(19) United States
(12) Patent Application Publication
(10) Pub. No.: US 2022/0220782 A1
(43) Pub. Date: Jul. 14, 2022

(54) MULTIFUNCTIONAL AUTOMOTIVE LATCH

(71) Applicant: STRATTEC SECURITY CORPORATION, Milwaukee, WI (US)

(72) Inventors: Michael Strole, Royal Oak, MI (US); Ian Martin, Waterford, MI (US); Walter Pipp, Birmingham, MI (US)

(21) Appl. No.: 17/144,648

(22) Filed: Jan. 8, 2021

(51) Int. Cl. E05B 85/02; E05B 83/00; B62D 33/037; B60P 7/08

(52) U.S. Cl. CPC E05B 85/02; E05B 83/00; E05Y 2900/546; B60P 7/0807; B62D 33/037

(57) ABSTRACT

An automotive latch assembly includes an outer housing, a latching element at least partially housed within the outer housing, and at least one of a tie-down feature or bottle opener feature that is an aperture that extends through an element of the latching assembly.

### BACKGROUND

This disclosure relates to latch assemblies, such as those used in automotive applications including but not limited to truck end gates or “tailgate” latches, latches for vehicular rear hatches, lift gate latches, latches for trunks, latches for side entry doors, or any other automotive latch assemblies.

### SUMMARY

In one aspect, the disclosure provides an automotive latch assembly having an outer housing, and a latching element at least partially housed within the outer housing. The automotive latch assembly also includes a tie-down feature configured to facilitate attachment of a tie-down strap to the latch assembly. The tie-down feature is an aperture that extends through an element of the latching assembly.

In another aspect, the disclosure provides an automotive latch assembly having an outer housing, and a latching element at least partially housed within the outer housing. The automotive latch assembly also includes a bottle opener feature configured to facilitate removal of a bottle cap. The bottle opener feature is an aperture that extends through an element of the latching assembly.

Other embodiments and aspects of various embodiments will become apparent by consideration of the detailed description and accompanying drawings.

### BRIEF DESCRIPTION OF THE DRAWINGS

FIG. 1 is a perspective view of a motor vehicle having latch assemblies, illustrated schematically, that are located on a tailgate of the motor vehicle.

FIG. 2 is a front view of the latch assembly according to one embodiment, the latch assembly having both a tie-down feature as well as a bottle opener feature.

FIG. 3 is a bottom perspective view of the latch assembly of FIG. 2.

FIG. 4 is a perspective view of the latch assembly of FIG. 2, illustrating the latch assembly on the tailgate of FIG. 1 and the tie-down feature being used.

FIG. 5 is a perspective view of the latch assembly of FIG. 2, illustrating the bottle opener feature being used.

### DETAILED DESCRIPTION

Before any embodiments are explained in detail, it is to be understood that embodiments are not limited in their application to the details of construction and the arrangement of components set forth in the following description or illustrated in the following drawings. Other embodiments are possible and embodiments described and illustrated are capable of being practiced or of being carried out in various ways.

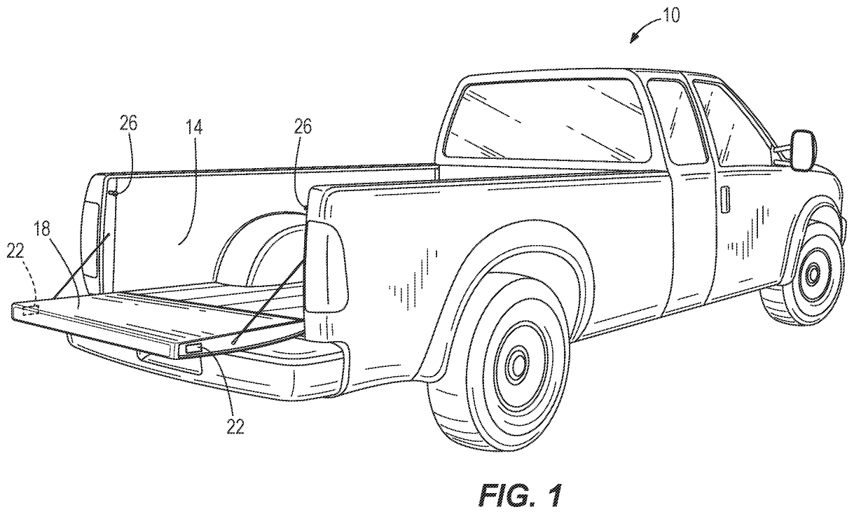

FIG. 1 illustrates a motor vehicle 10 (e.g., pick-up truck) having a cargo bed 14 and a tailgate 18 that pivots between a raised position and a lowered position relative to the cargo bed 14. The tailgate 18 is pivoted to the lowered position in FIG. 1. The tailgate 18 may be a manually operated tailgate 18, or for example a powered tailgate 18 that is lifted and/or lowered with the assistance of an actuator (e.g., motor).

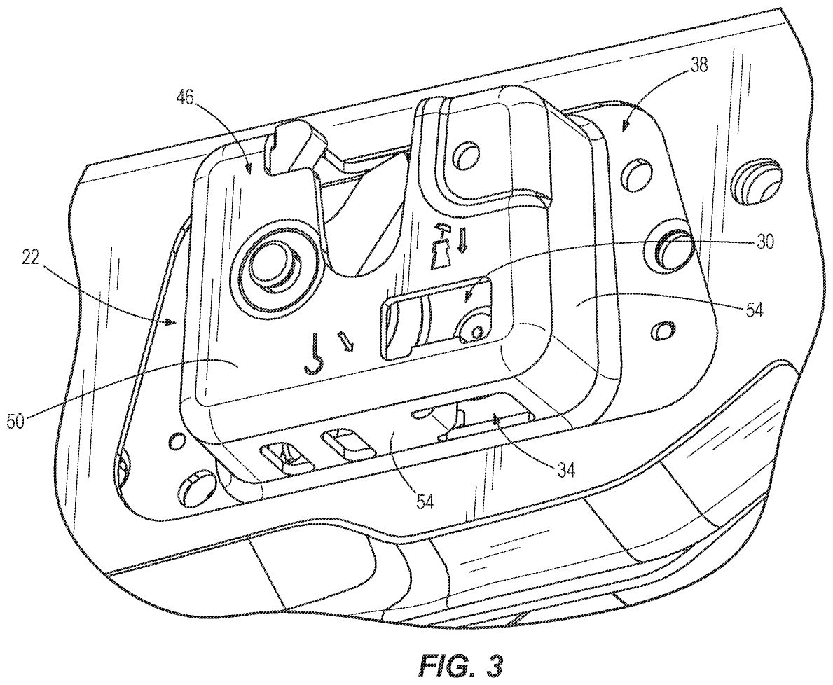

As illustrated in FIGS. 1-4, one or more latch assemblies 22 are positioned on the tailgate 18 (e.g., along sides of the tailgate 18). Each latch assembly 22 may be used to releasable lock the tailgate 18 in place relative to the cargo bed 14. In the illustrated embodiment, at least one of the latch assemblies 22 is positioned to releasably lock the tailgate 18 in place relative to the cargo bed 14 when the tailgate 18 is in the raised position. While the latch assemblies 22 in the illustrated embodiment are used on a pick-up truck to selectively hold shut the tailgate 18, the latch assembly or assemblies 22 may be used to selectively hold shut other components on automotive vehicles or other structures. For example, the latch assembly or assemblies 22 may be used to selectively hold shut a vehicle entry door, a hatch, a decklid, a trunk, or various other structures.

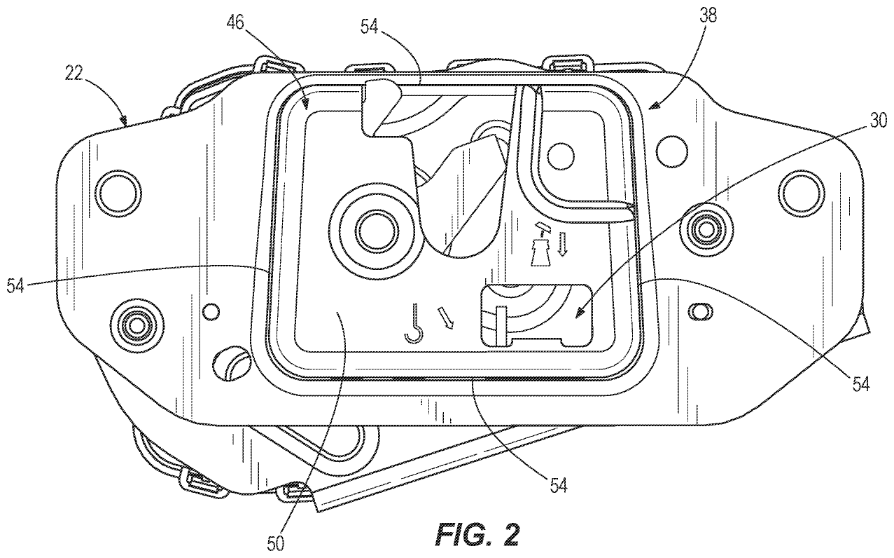

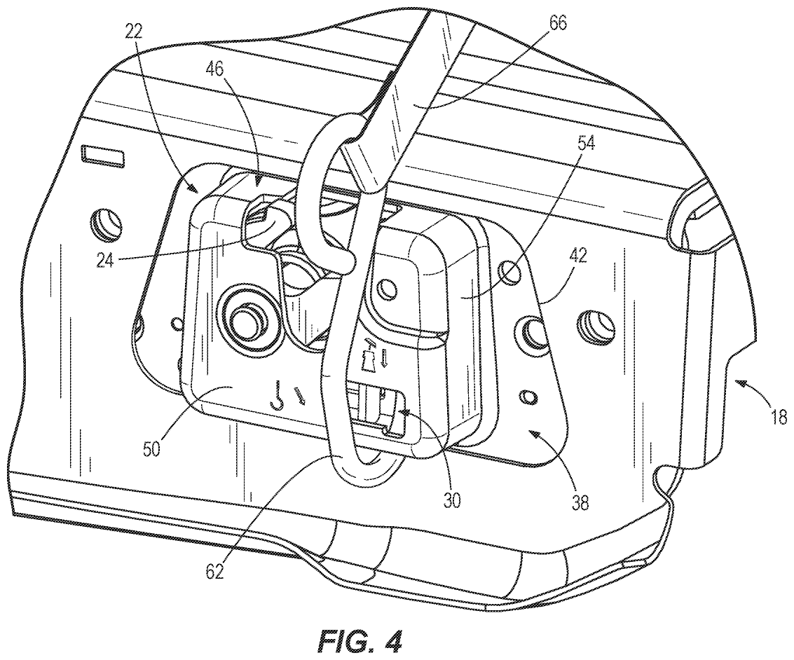

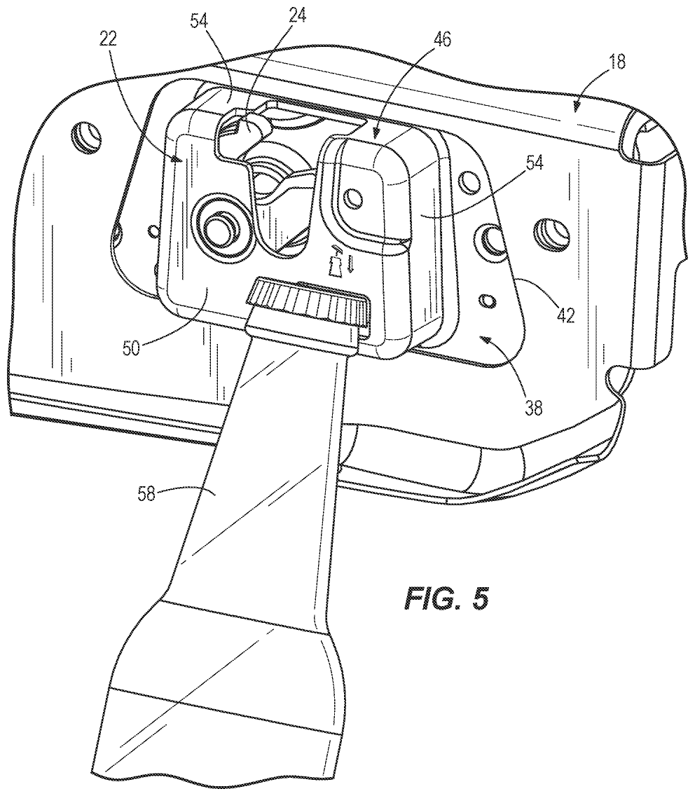

With reference to FIGS. 2-5, in some embodiments the latch assembly 22 includes a catch 24 (e.g., forkbolt, seen partially in FIGS. 4 and 5) and a pawl (e.g., detent lever). The catch 24 may be rotatable about a first axis to selectively engage and trap a striker such as a striker 26 (FIG. 1) located on the cargo bed 14. In other embodiments the striker 26 may be located on another component of a vehicle (e.g., pillar, side frame, etc.). The detent lever of the latch assembly 22 may include an engagement surface configured to engage one or more corresponding engagement surfaces of the catch 24 to retain the catch 24 in one or more latched positions, retaining the striker 26. In some vehicles, the positions of the striker 26 and the latch assembly 22 can be reversed. For example, the latch assembly 22 may be located on the cargo bed 14 (or pillar, side frame, etc. of a vehicle) and the striker 26 may be located on the tailgate 18 (or along a rear hatch, lift gate, trunk etc.).

Other embodiments include latch assemblies 22 at different locations on the motor vehicle 10 than that illustrated, as well as on other types of vehicles or structures than that illustrated (e.g. on minivans, sedans, RVs, etc.). Additionally, other embodiments include latch assemblies 22 having components other than the catch 24 described above.

With reference to FIGS. 2-5, the latch assembly 22 includes at least one of a bottle opener feature 30 (e.g., to facilitate removing a bottle cap from a bottle) and a tie-down feature 34 (e.g., to facilitate tying down an object to the motor vehicle 10). In the illustrated embodiment, the latch assembly 22 includes an outer housing 38 having both the bottle opener feature 30 and the tie-down feature 34. The outer housing 38 at least partially houses one or more latching elements (e.g., the catch 24, a pawl, or other latching elements such as hooks, detents, etc. that may engage a striker 26 or other similar component to latch an element in place). The outer housing 38 may be fixed to the rest of the latch assembly 22 (e.g., to another housing via fasteners), or may be integrally formed as a single piece with the rest of the latch assembly 22. In some embodiments the outer housing 38 is a thin plate (e.g., comprised of metal or other suitable material). As illustrated in FIGS. 2-5, the outer housing 38 includes apertures extending through the outer housing 38. In some embodiments, the latch assembly 22 may include a forkbolt or detent that are each at least partially enclosed and housed by the outer housing 38. As illustrated in FIGS. 2-5, the outer housing 38 may be planar in one or more regions, and may be curved or non-planar in other regions. Other embodiments include different shapes and sizes for the outer housing 38 than that illustrated, as well as other numbers of apertures.

With reference to FIGS. 4 and 5, the tailgate 18 includes an aperture 42 along a side of the tailgate 18. In the illustrated embodiment a central portion 46 of the outer housing 38 extends at least partially through the aperture 42, such that the central portion 46 of the outer housing 38 is exposed and accessible along the side of the tailgate 18 when the tailgate 18 is released from the raised (closed) position and is pivoted down to the lowered (open) position. The central portion 46 has elements including a front wall 50 that faces away from the tailgate 18, as well as four side walls 54 that are generally perpendicular to the front wall 50 and form a periphery around the front wall 50, and together with the front wall 50 form a generally rectangular-shaped, three-dimensional region of the outer housing 38. Other embodiments include different sizes and shapes for the outer housing 38 than that illustrated, including central portions 46 having other sizes and shapes. In some embodiments the outer housing 38 (or latch assembly 22 itself) does not extend through an aperture (e.g., aperture 42) in the tailgate 18. Rather, the latch assembly 22 is coupled to an outside of the tailgate 18, or to whatever structure the latch assembly 22 is being used for (e.g., a vehicle entry door, a hatch, a decklid, a trunk, etc.).

With reference to FIGS. 2-5, in the illustrated embodiment the central portion 46 includes both the bottle opener feature 30 and the tie-down feature 34. The bottle opener feature 30 is an aperture that extends through the front wall 50, near a lower corner of the front wall 50. In other embodiments the bottle opener feature 30 is an aperture that extends through one of the side walls 54, or along a combination of the front wall 50 and one of the side walls 54, or is located at a different location along one of the walls 50, 54 than that illustrated. In yet other embodiments the bottle opener feature 30 is an aperture that is located elsewhere along the outer housing 38 or other portion of the latch assembly 22 than that illustrated. The bottle opener feature 30 is sized and shaped such that when the tailgate 18 is open (FIG. 1), an end of a bottle 58 (FIG. 5) may be inserted into the bottle opener feature 30 and the cap of the bottle 58 may be removed (e.g., by twisting or otherwise moving the bottle 58). Other embodiments include different shapes and sizes for the bottle opener feature 30 than that illustrated.

With continued reference to FIGS. 2-5, the tie-down feature 34 is an aperture that extends through outer housing 38. In the illustrated embodiment the tie-down feature 34 is an aperture located on a lower side wall 54, near the same corner of the outer housing 38 as the bottle opener feature 30, such that the bottle opener feature 30 and the tie-down feature 34 are adjacent one another. In other embodiments the tie-down feature 34 is an aperture that extends through a different one of the side walls 54, or extends through the front wall 50, or along a combination of the front wall 50 and one of the side walls 54. In yet other embodiments the tie-down feature 34 is an aperture that is located elsewhere along the outer housing 38 or other portion of the latch assembly 22 than that illustrated. The tie-down feature 34 is sized and shaped such that a hook 62 (FIG. 4) or other securing structure may be inserted into the tie-down feature 34 and may engage (e.g., hook onto) the outer housing 38. In the illustrated embodiment the hook 62 is coupled to a tie-down strap 66. The hook 62 and tie-down strap 66 may be used, for example, to secure a piece of cargo that is in the cargo bed 14 when the tailgate 18 is open. Alternatively, the hook 62 and tie-down strap 66 may be used to hold the tailgate 18 itself in a given position. In some embodiments, a second hook 62 may be coupled to an opposite end of the tie-down strap 66 (not shown), and the second hook 62 may be engaged with a second latch assembly 22 (e.g., on an opposite side of the tailgate 18). The second latch assembly 22 may be identical to the latch assembly 22 illustrated in FIGS. 2-5. Other embodiments include different shapes and sizes for the tie-down feature 34 than that illustrated.

In some embodiments, the bottle opener feature 30 and/or the tie-down feature 34 may be part of an additional element that is added to the latch assembly 22 to integrate the bottle opener feature 30 and/or the tie-down feature 34 into the latch assembly 22. For example, an additional bracket or brackets may be added to (e.g., separately fixed to or integrally formed as part of) the latch assembly 22 (e.g., fixed to the outer housing 38 or to another area of the latch assembly 22). The additional bracket(s) may include the bottle opener feature 30 and/or the tie-down feature 34. Thus, rather than a wall of outer housing 38 having the tie-down and/or bottle opener features 30, 34, the additional element (e.g., bracket, wall, protrusion, etc.) of the latch assembly instead would include the tie-down and/or bottle opener features 30, 34.

Overall, the latch assembly 22 described herein may be used as a multifunctional latch assembly on a vehicle or other structure. The latch assembly 22 may incorporate at least one of the bottle opener feature 30 and tie-down feature 34. By incorporating these features with the latch assembly 22, the latch assembly 22 may serve not only as a latch, but also for providing an area to open a bottle and as an area for a tie-down.

Although various embodiments have been described in detail with reference to certain examples illustrated in the drawings, variations and modifications exist within the scope and spirit of one or more independent aspects described and illustrated.

1. An automotive latch assembly comprising:
an outer housing;
a latching element at least partially housed within the outer housing; and
a tie-down feature configured to facilitate attachment of a tie-down strap to the latch assembly, wherein the tie-down feature is an aperture that extends through an element of the latch assembly.

2. The automotive latch assembly of claim 1, wherein the element of the latch assembly is a wall of the outer housing.

3. The automotive latch assembly of claim 2, wherein the wall includes a front wall, and side walls extending from the front wall, wherein the aperture is disposed in one of the side walls.

4. The automotive latch assembly of claim 3, wherein side walls include four side walls forming a periphery around the front wall.

5. The automotive latch assembly of claim 1, wherein the latching element is a forkbolt.

6. A vehicle comprising:
a tailgate; and
the automotive latch assembly of claim 1 coupled to the tailgate.

7. The vehicle of claim 6, wherein the aperture is a first aperture, wherein the tailgate includes a second aperture, wherein a portion of the outer housing extends through the second aperture.

8. The vehicle of claim 6, wherein the tailgate is movable from a raised, closed position to a lowered, open position, wherein the tie-down feature is accessible when the tailgate is in the open position.

9. The automotive latch assembly of claim 1, wherein the aperture is a first aperture and the element is a first element, wherein the automotive latch assembly further includes a bottle opener feature configured to facilitate removal of a bottle cap, wherein the bottle opener feature is a second aperture that extends through a second element of the latch assembly.

10. The automotive latch assembly of claim 9, wherein the outer housing includes a front wall, and side walls extending from the front wall, wherein the first aperture is disposed in one of the side walls, and wherein the second aperture is disposed on the front wall.

11. The automotive latch assembly of claim 10, wherein the first aperture is disposed adjacent the second aperture, at a corner of the outer housing.

12. A vehicle comprising:
a tailgate; and
the automotive latch assembly of claim 10.

13. An automotive latch assembly comprising:
an outer housing;
a latching element at least partially housed within the outer housing; and
a bottle opener feature configured to facilitate removal of a bottle cap, wherein the bottle opener feature is an aperture that extends through an element of the latch assembly.

14. The automotive latch assembly of claim 13, wherein the element of the latch assembly is a wall of the outer housing.

15. The automotive latch assembly of claim 14, wherein the wall includes a front wall, and side walls extending from the front wall, wherein the aperture is disposed in the front wall.

16. The automotive latch assembly of claim 15, wherein the side walls include four side walls forming a periphery around the front wall.

17. The automotive latch assembly of claim 13, wherein the latching element is a forkbolt.

18. A vehicle comprising:
a tailgate; and
the automotive latch assembly of claim 13 coupled to the tailgate.

19. The vehicle of claim 18, wherein the aperture is a first aperture, wherein the tailgate includes a second aperture, wherein a portion of the outer housing extends through the second aperture.

20. The vehicle of claim 18, wherein the tailgate is movable from a raised, closed position to a lowered, open position, and wherein the bottle opener feature is accessible when the tailgate is in the open position.
